(19) United States
(12) Patent Application Publication
(10) Pub. No.: US 2021/0402712 A1
(43) Pub. Date: Dec. 30, 2021

(54) METHOD FOR PRODUCING A JOINT CONNECTION BETWEEN A LIGHT-GIVING/OPTICS PLASTIC COMPONENT AND A METAL COMPONENT

(71) Applicant: HELLA GmbH & Co. KGaA, Lippstadt (DE)

(72) Inventors: Michael LAKENBRINK, Oelde (DE); Jan Daniel WENZEL, Hamm (DE); Thomas WIESE, Lippstadt (DE)

(73) Assignee: HELLA GmbH & Co. KGaA, Lippstadt (DE)

(21) Appl. No.: 17/473,445

(22) Filed: Sep. 13, 2021

Related U.S. Application Data
(63) Continuation of application No. PCT/EP2020/054594, filed on Feb. 21, 2020.

(30) Foreign Application Priority Data
Mar. 12, 2019 (DE) 10 2019 106 260.8

(51) Int. Cl. B29C 65/00; B29C 65/14; B29C 65/16; F16B 5/08

(52) U.S. Cl. CPC B29C 66/227; B29C 65/1412; B29L 2031/30; B29C 66/742; F16B 5/08; B29C 65/16

(57) ABSTRACT

A method for manufacturing a joining connection between a luminously efficacious part and a metal component of a lighting device of a vehicle. A microstructure is generated in a joining surface of the metal component, the microstructure having undercuts with respect to the joining surface. The plastic material of the plastic part is softened in an area of the complementary joining surface near the surface with the aid of an introduction of heat. The plastic part and the metal component are pressed together with a pressure force in such a way that a portion of the softened plastic material penetrates the undercuts of the microstructure. The plastic material of the plastic part is cooled thereby forming a new strength of the softened plastic material of the plastic part.

This nonprovisional application is a continuation of International Application No. PCT/EP2020/054594, which was filed on Feb. 21, 2020 and which claims priority to German Patent Application No. 10 2019 106 260.8, which was filed in Germany on Mar. 12, 2019 and which are both herein incorporated by reference.

### BACKGROUND OF THE INVENTION

### Field of the Invention

The present invention relates to a method for manufacturing a joining connection between a luminously efficacious plastic part and a metal component, and a metal component of a lighting device of a vehicle.

### Description of the Background Art

A joint between a luminously efficacious plastic part and a metal component is known from DE 10 2014 109 114 A1, which corresponds to U.S. Pat. No. 10,145,530, which is incorporated herein by reference. To join the plastic component to the metal component, a latching hook is shown by way of example on a first side and a screw element on an opposite second side. The example illustrates that connections between plastic parts and metal components in the construction of lighting devices for vehicles are usually complex and require multiple additional parts, adhesive joints or clamping joints being used to avoid geometric form-fitting connections, such as latching hooks and the like, and/or to avoid screw elements. The use of holding elements, such as springs and the like, is also common.

A disadvatage results in the conventional art in a complex design and installation of the joining connection, and multiple additional components or additional materials, such as screws, springs or adhesives and the like, are generally necessary.

A further disadvantage arises if a single-point, force-transferring connection is generated, for example in a screw connection or riveted connection, which occurs upon a mechanical loading of the joint. The connection is, in part, subjected to a high load, and the material, i.e. the plastic or the metal, may experience high local stresses in the connection area. Undesirable deformations result thereby, which are to be avoided, in particular in the case of narrow tolerances; he same is true with regard to the location and arrangement of luminously efficacious parts, such as illuminant carriers, reflectors, lenses, light conductors and the like.

A method for manufacturing a joining connection is known from DE 10 2017 214 518 A1, in which a cast component is connected to a metallic structural element. The metallic structural element must be generatively manufactured, for example by powder bed methods, by selective laser sintering or selective laser melting. The surface of the metallic structural element has a surface structure, which comprises microdepressions, into which the casting material of the cast components may penetrate. This results in a form-fitting micro-joint formed over a wide area between the metallic structural element and the cast component. The applicability of the presented joining technology is disadvantageously transferable only to a limited extent, since not every metallic structural element may be manufactured using generative methods, in particular not for cost reasons, and a farther-reaching application is the method is moreover not known without forming a form-fit between the structural element and the cast component. The joining components are joined one inside the other in a form-fitting manner here.

### SUMMARY OF THE INVENTION

It is therefore an object of the present invention to provide a method for manufacturing a joining connection between a luminously efficacious plastic part and a metal component of a lighting device of a vehicle. The method is intended to easily result in a joint, which may be subjected to a high mechanical load, which is as gas- and liquid-tight as possible and does not cause any high-single-point stresses in the plastic part and/or in the metal component. It is furthermore desirable if the method for manufacturing the joining connection, and thus the joint, makes it possible to easily maintain narrow tolerances without subsequent adjustment work being necessary.

The method according to an exemplary embodiment of the invention for manufacturing a joining connection between a luminously efficacious plastic part and a metal component of a lighting device of a vehicle proposes the following steps: Generating a microstructure in a joining surface of the metal component, the microstructure having undercuts with respect to the joining surface; softening the plastic material of the plastic part in an area near the surface of the complementary joining surface by introducing heat; pressing the plastic part and the metal component together with a pressure force in such a way that a portion of the softened plastic material penetrates the undercuts of the microstructure; and cooling the plastic material of the plastic part, forming a new strength of the softened plastic material of the structural part. Of course, the metal component may also be heated prior to the actual joining process, so that the luminously efficacious plastic part is not already immediately cooled at the metal component when the contact of the two joining partners is manufactured.

If the method according to the invention for manufacturing a joining connection between a luminously efficacious plastic part and a metal component is used for an installation in a lighting device of a vehicle, the generally sensitive luminously efficacious plastic parts to be installed in precise locations, such as lenses, light conductors, thick-walled optical elements, reflectors, illuminant carriers and the like, may be easily mounted on a metal component, and no additional elements, such as screws, clamping elements or springs, are necessary. Moreover, no joining substances, such as adhesives or the like, are needed.

The mounting of the joining connections in the lighting device may be improved with the aid of the joined metallic components as holding elements, for example when installing light modules in a headlamp, have improved properties, in particular the fastening of solid luminous parts, such as thick-walled light conductors. Optically transparent materials, such as PMMA or certain PC plastic types, have a high brittleness, which very often results in substantial problems with the load-tolerant fastening of the parts. The advantage of the joining connection according to the invention is the connection over a wide area without generating single-point joining connections, such as in a screw connection, so that no tension peaks occur in the sensitive luminous part.

The introduction of heat with the aid of contact heating elements is particularly advantageously generated with the aid of a laser irradiation or with the aid of an IR irradiation of the complementary joining surface of the plastic part. The complementary joining surface forms the surface situated opposite the joining surface on the metal component. It is also conceivable that the metal component is heated and brought into contact with the plastic part. By a transfer of heat from the metal component into the plastic part, the area near the surface of the plastic part in the joining surface is already heated and thus softened, so that the softened plastic material may penetrate the undercuts of the microstructure in the metal component. The introduction of heat may also take place by induction or being held in a furnace or by further suitable methods.

Further, material tongues penetrating the microstructure can be formed during the pressing together of the plastic part and the metal component with the softened plastic material, by means of which a form fit and/or a force fit is/are formed with the metal component. For example, the microstructure has grooves or notches in the surface of the metal component, which penetrate the body of the metal component so as to run at an incline with respect to the surface. The inclination angle of the grooves or holes in the metal component may be alternately changed, so that the plastic part may not be detached from the metal component in an extraction direction. In addition, it is possible to design the microstructure itself with undercuts, for example with the aid of increasing lateral dimensions of a microstructure at a greater depth within the metal component. Microstructures of this type may be produced, for example, by laser-based material removal or with the aid of etching methods. The geometric dimensions of the microstructures may be, for example 10 μm to 1,000 μm.

The microstructure in the joining surface of the metal component may have indentations or elevations. If the microstructure in the joining surface is provided with a raised design, the elevations penetrate the softened plastic and are surrounded thereby, so that a form fit and/or a force fit is/are formed after cooling the plastic.

If material tongues form within the microstructure, which also run, in particular, at an incline to the surface and are oriented in different directions of incline, distributed over the joining surface, a form fit results between the plastic part and the metal component. A force fit may also be formed, in particular due to slight shrinkage processes during the cooling of the plastic material, in particular in the area of the material tongues. The plastic part interlocks with the surface of the metal component thereby in a certain way. The connection is thus permanently manufactured and, in particular, liquid- and gas-tight. A joining connection of this type may be used for optical elements which are mounted on holders or the like, or metal components may, in turn, be mounted on the optical element itself, for example if the latter has large dimensions. A joining connection of this type is particularly advantageous for producing undercuts and hollow spaces, so that, for example, a pot-cover structure may be generated, this structure not being able to be generated, for example, by injection molding.

The joining surface with the microstructure is further advantageously selected to be of the same size or smaller than a contact surface between the plastic part and the metal component. Surface sections having a transfer of force between the plastic part and the metal component may be created in a targeted manner, which may be designed in such a way that only slight mechanical loads occur in the joining zones, so that the actual contact surface between the parts may be significantly larger than the joining surface. Due to the only local use of the connection, contact areas between the plastic part and the metal component may be generated in a targeted manner, which are arranged in such a way that an ideal transfer of force is achieved between the plastic part and the metal component. The size of the joining surface is selected in such a way that the specific surface load during the transfer of force remains significantly below a damage limit.

It is also advantageous that a single joining surface or multiple joining surfaces individually separated from each other having the microstructure are formed on a contact surface between the plastic part and the metal component. For example, in the case of a rectangular contact surface between an optical element and a metallic carrier body, joining surfaces may be provided in the four corners of the rectangular shape, so that only a local heating, and no full-surface heating, of the surface of the plastic part is necessary.

The metal component is further advantageously formed with the aid of an Mg alloy, an AL alloy, a Zn alloy or an Fe alloy, and/or the metal component is manufactured by means of a die casting method, an extrusion method, a forging method, with the aid of a machining manufacturing process and/or with the aid of a stamping/bending method.

With respect to the luminously efficacious plastic component, the latter is advantageously designed in such a way that it is irradiated or through-irradiated during the operation of the lighting device with the aid of at least one light beam generated by a light source in the lighting device, and/or the luminously efficacious plastic part is designed as a reflector, a light conducting body, a thick-walled optical element or a primary optical element.

It is also advantageous if a holder of the luminously efficacious plastic part is formed with the metal component, and/or if the metal component has a diaphragm edge, with the aid of which a aperture effect is achieved.

The joining surface with the microstructure between the plastic part and the metal component is advantageously selected in such a way that a thermal compensation of the location of the plastic part as a reflector, as a light-conducting body, as a thick-walled optical element or as a primary optical element relative to the installation environment is achieved with the aid of the different coefficients of thermal expansion between the plastic part and the metal component.

The plastic part and the metal component may have coefficients of thermal expansion which differ from each other, and the joining surface may be placed between the metal component and the plastic part in such a way that a temperature drift is compensated for by utilizing the different coefficients of thermal expansion, for example, within luminously relevant positional tolerances of an optical part as the plastic part.

It is also advantageous if the plastic part and the metal component are pressed against each other with a handling system for the purpose of manufacturing the joint, the handling system being controlled in such a way that the location of the luminously efficacious plastic part is positioned in a compensating position on or at the metal component for the purpose of compensating for tolerances.

The plastic part may be positioned relative to the metal component within certain limits while the plastic material near the surface is still softened. When the plastic material of the plastic part cools again, the set, highly accurate position is frozen in a certain way, so that a positional tolerance of the plastic part relative to the metal component remains permanently set.

The invention is furthermore directed to a joint made up of a luminously efficacious plastic part and a metal component, the joint being manufactured with the aid of the method described above. In particular, the metal component forms a holder of the luminously efficacious plastic part, and/or the metal component has a diaphragm edge, with the aid of which an aperture effect may be generated by a light which may be radiated through or onto the plastic part.

A further advantage is achieved in that the metal component may provide a thermal protection, e.g., against sunlight or a cooling of the luminous part and/or a light source, if the latter is arranged on the plastic component.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic cross-sectional view of the joint between the plastic part and the metal component;

FIG. 2 shows a view of a luminously efficacious plastic part in an arrangement on a metal component;

FIG. 3 shows the view of a metal component, including a diaphragm section, in an arrangement on a luminously efficacious plastic part; and

FIG. 4 shows a plastic part designed as a reflector in an arrangement on a metal component designed as a cooling body.

### DETAILED DESCRIPTION

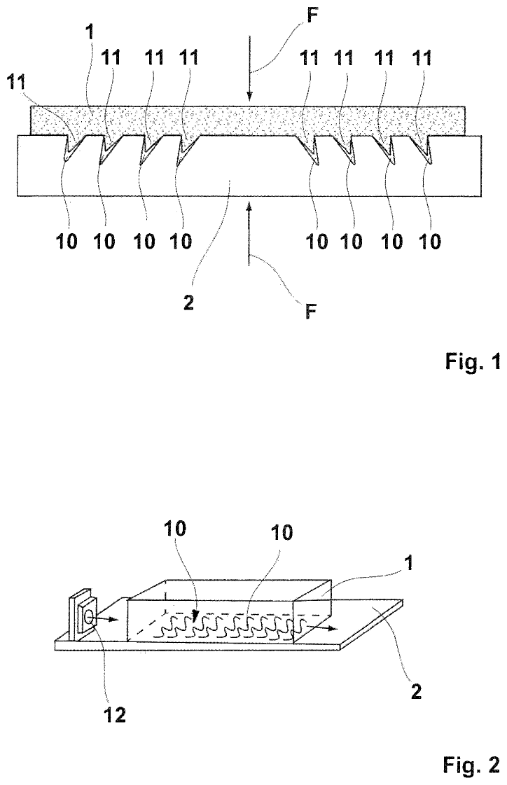

FIG. 1 shows a cross-sectional view of a joint between a plastic part 1 and a metal component 2. Plastic part 1 is illustrated in an abstracted manner and is therefore provided with a luminously efficacious design, which is not shown in further detail, and describes, for example, a reflective or transmissive optical element of a light module in a lighting device of a vehicle, for example in a headlamp. Metal component 2 may be, for example, a holder, a diaphragm or another retrofit part of the reflective or transmissive optical element, for example a cooling body.

Microstructures 10, which run at an incline starting from the surface into the body of metal component 2, are introduced into the surface of metal component 2 used as a contact surface to plastic part 1, the angle of inclination of the microstructures pointing in different directions, discernibly illustrated by way of example with left-side microstructures 10, with right-side microstructures 10 oriented in the opposite direction.

Microstructures 10 have been introduced into metal component 2, for example using a laser-based material removal method or an etching method. The representation of microstructure 10 is provided with an oversized design with reference to the thickness of metal component 2, and it is sufficient if microstructure 10 runs into the material at a depth of, for example, less than 1,000 μm, less than 500 μm or less than 200 μm starting from the surface.

To generate the joining connection, the complementary contact area of plastic part 1, i.e. the contact area opposite metal component 2, is first heated, for example using contact heating elements, by means of laser irradiation or by means of IR irradiation. Plastic part 1 is pressed with its subsequently softened surface onto microstructure 10 of metal component 2, applied pressure force F being represented by arrows. A portion of the softened plastic material of plastic part 1 then penetrates microstructure 10 and forms material tongues 11, which interlock with undercut microstructure 10 after a cooling of plastic part 1 and thus form a form fit and possibly additionally a friction fit. A mechanically loadable joining connection is generated thereby between plastic part 1 and metal component 2 without a macroscopic form fit being necessary.

FIG. 2 shows an example of a transmissive optical element in the form of plastic part 1, into which light may be irradiated with the aid of a light source 12, and which may be coupled out again on an opposite side, as indicated by arrows. Plastic part 1 is mounted on a metal component 2, and the contact area between plastic part 1 and metal component 2 has microstructures 10, via which a connection between plastic part 1 and metal component 2 is generated using the method described above.

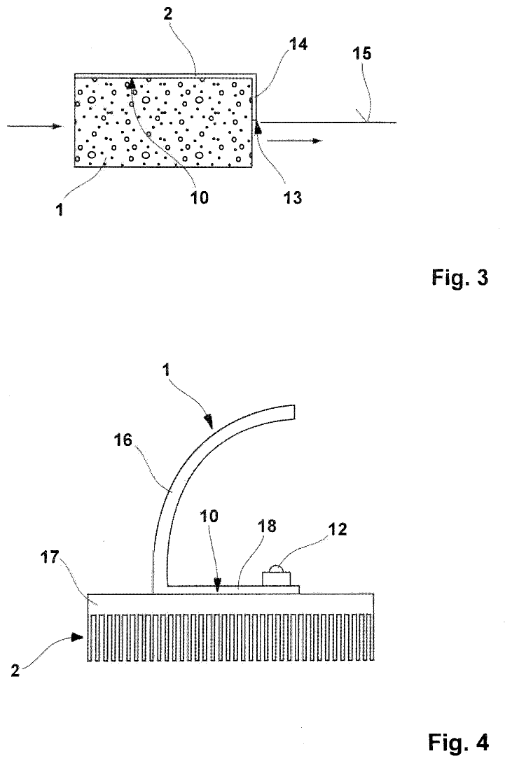

FIG. 3 shows a further exemplary embodiment of a joining connection between a plastic part 1 and a metal component 2, plastic part 1 being a luminously efficacious part, for example a light conducting body of a solid design. Metal component 2 is mounted on an upper side, and it includes a diaphragm section 14 having a diaphragm edge 13. The example shows a light/dark boundary 15 upon a through-irradiation of plastic part 1, which is generated with the aid of diaphragm edge 13. Microstructure 10 introduced into the contact surface of metal component 2, into which the heated plastic of plastic part 1 may penetrate, is used to fasten metal component 2 on plastic part 1, so that the illustrated structure does not require any adhesive or the like, and metal component 2 is nevertheless fixedly arranged on plastic part 1.

FIG. 4 shows an application of a plastic part 1 in the form of a reflector 16 and a metal component 2 in the form of a cooling body 17. Once again, the contact area of metal component 2 is provided with a microstructure 10, so that a reflector base 18 of reflector 16 may be mounted on the surface of cooling body 17. If light source 12 is operated, the generated contact between plastic part 1 and metal component 2 may result in an advantageous heating thereof.

The design of the invention is not limited to the preferred exemplary embodiment specified above. Instead, a number of variants are conceivable, which make use of the illustrated approach, even in fundamentally different designs. All features and/or advantages arising from the claims, the description or the drawings, including structural details, spatial arrangements and method steps, may be essential to the invention individually as well as in a wide range of combinations.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for manufacturing a joining connection between a luminously efficacious part and a metal component of a lighting device of a vehicle, the method comprising:
generating a microstructure in a joining surface of the metal component, the microstructure having undercuts with respect to the joining surface;
softening a plastic material of a plastic part in an area of the complementary joining surface near the surface with the aid of an introduction of heat;
pressing the plastic part and the metal component together with a pressure force such that a portion of the softened plastic material penetrates the undercuts of the microstructure; and
cooling the plastic material of the plastic part to form a new strength of the softened plastic material of the plastic part.

2. The method according to claim 1, wherein the introduction of heat is generated with the aid of contact heating elements by a laser irradiation or by an IR irradiation.

3. The method according to claim 1, wherein material tongues, which penetrate the microstructure with the softened material, are formed when pressing together the plastic part and the metal component via which a form fit and/or a force fit is/are formed with the metal component.

4. The method according to claim 1, wherein the joining surface with the microstructure is of the same size or smaller than a contact surface between the plastic part and the metal component.

5. The method according to claim 1, wherein a single joining surface or multiple individually separately formed joining surfaces having the microstructure are formed on a contact surface between the plastic part and the metal component.

6. The method according to claim 1, wherein the metal component is formed with the aid of an Mg alloy, an Al alloy, a Zn alloy or an Fe alloy, and/or is manufactured by a die casting method, an extrusion method, a forging method, with the aid of a machining manufacturing process and/or with the aid of a stamping/bending method.

7. The method according to claim 1, wherein the luminously efficacious plastic component is designed such that it is irradiated or through-irradiated during the operation of the lighting device with the aid of at least one light beam generated by a light source in the lighting device, and/or the luminously efficacious plastic part is designed as a reflector, a light conducting body, a thick-walled optical element or a primary optical element.

8. The method according to claim 1, wherein a holder of the luminously efficacious plastic part is formed with the metal component, and/or the metal component has a diaphragm edge, with the aid of which an aperture effect is achieved.

9. The method according to claim 1, wherein the joining surface having the microstructure between the plastic part and the metal component is selected such that a thermal compensation of the location of the plastic part as a reflector, as a light-conducting body, as a thick-walled optical element or as a primary optical element relative to the installation environment is achieved with the aid of the different coefficients of thermal expansion between the plastic part and the metal component.

10. The method according to claim 1, wherein the plastic part and the metal component are pressed against each other with a handling system, the handling system being controlled such that the location of the luminously efficacious plastic part is positioned in a compensating position on or at the metal component for the purpose of compensating for tolerances.

11. A joint made up of a luminously efficacious plastic part and a metal component, manufactured via the method according to claim 1.

12. The joint according to claim 11, wherein the metal component forms a holder of the luminously efficacious plastic part and/or the metal component has a diaphragm edge, with the aid of which an aperture effect may be generated by a light which is adapted to be irradiated through or onto the plastic part.
